(19) United States
(12) Patent Application Publication
(10) Pub. No.: US 2005/0047894 A1
(43) Pub. Date: Mar. 3, 2005

(54) Method for binding graphic products

(75) Inventor: Peter Merkli, Oftringen (CH)

Correspondence Address: VENABLE, BAETJER, HOWARD AND CIVILETTI, LLP, P.O. BOX 34385, WASHINGTON, DC, 20043-9998, US

(73) Assignee: MULLER MARTINI HOLDING AG, Hergiswil (CH)

(21) Appl. No.: 10/933,547

(22) Filed: Sep. 3, 2004

(30) Foreign Application Priority Data
Sep. 3, 2003 (EP) 03405637.4

(51) Int. Cl. B42B 5/00

(52) U.S. Cl. 412/33

(57) ABSTRACT

A method for binding graphic products formed of folded signatures securely joined along a folded back end of the signatures includes providing at least one flexible tab and providing each signature, respectively, with at least one slit in a region of a fold. The tab is pulled into the slit for joining the signatures.

### CROSS-REFERENCE TO RELATED APPLICATION

This application claims the priority of European Patent Application No. 03405637.4, filed on Sep. 3, 2003, the subject matter of which is incorporated herein by reference.

### BACKGROUND OF THE INVENTION

The invention relates to a method for binding graphic products, wherein folded signatures are fixedly joined along a back with the aid of joining means.

Methods for binding graphic products such as books, brochures or magazines have long been known, wherein three methods in particular have proven themselves in practical operations. These methods include wire-stitching, thread-stitching and perfect binding.

With the wire-stitching method, folded signatures are stitched together along the back with a wire staple in a comparatively fast and cheap mechanical operation. The disadvantage of wire-stitching is that it carries a certain injury risk if the wire-staple legs are not bent correctly. For children's books in particular this must be taken into consideration because small children can injure themselves on protruding wire staple legs. A further disadvantage is the undesirable increase in thickness caused by the wire staples. Since the wire-stitched print products comprise paper as well as metal, they are heterogeneous with respect to recycling and thus are not ideal candidates for recycling. However, an optimum recycling is essential, particularly for brochures and magazines.

Comparatively high-quality print products can be produced with the thread-stitching method. However, thread-stitching is mechanically demanding since it requires the use of very thin needles and, additionally, is comparatively slow.

For the perfect binding method, the signature backs are milled off and glued together by applying adhesive. Since the backs are first milled off, as mentioned, the binding with the applied adhesive occurs only along the milled edges. The disadvantage of the perfect binding method is that the holding power is comparatively low, particularly if a flat opening of the print, for example a book, is desired,

### SUMMARY OF THE INVENTION

It is an object of the present invention to make available a different binding method.

The above and other objects are achieved by the provision of a method for binding graphic products formed of folded signatures securely joined along a folded back end of the signatures, comprising: providing at least one flexible tab; providing each signature, respectively, with at least one slit in a region of a fold; and pulling the at least one tab into the at least one slit, respectively, for joining the signatures.

With the method according to the invention, the signatures are thus joined with the aid of flexible tabs, which are pulled through slits in the signature back and are then bent over. These tabs can be made of paper, textile materials or plastic, such that a product without metal parts is created, which also does not entail the risk of injury. Pulling a tab through a slit in a signature can be controlled easier mechanically than stitching together the signatures with thin needles. The durability and cohesion are considerably higher than with the perfect binding method since no milling of the signature backs is required. The product produced with the method according to the invention can be opened flat and can also be closed completely. In addition, there are no joining parts (e.g. staples) which cause a considerable increase in thickness.

According to one modification of the invention, the tab takes the form of a flap on one of the signatures, wherein the flap can be created by punching it out of the signature. However, it can also be a part of a paper signature that is not folded. At least two flaps, arranged at a distance to each other, are advantageously provided on a sheet and/or a signature. The length of the flap is measured such that it can be inserted through the slits in the signatures to be joined, can be bent over at one exposed end and affixed to the outer signature, in particular also glued on. However, these flaps can also project from the signature back and can be provided with holes for filing them in a ring binder. The signatures joined in this way can be bound inside a cover, for example with the aid of adhesive.

A particularly simple and durable binding is achieved if, according to another modification of the invention, the tab pulled into the slits in the signatures is bent over at one exposed end and is affixed to at least one signature, wherein the bent-over tab is preferably secured to the signature by gluing it on.

The invention furthermore relates to a graphic product produced with the method according to the invention. The product in particular is a book, a brochure, a magazine or the like.

### BRIEF DESCRIPTION OF THE DRAWINGS

Exemplary embodiments of the invention are explained in further detail in the following with the aid of the accompanying drawing.

FIG. 1 is a diagrammatic spatial view of a signature with two punched-out tabs.

FIG. 2 is a diagrammatic spatial view of a variant of a signature with two punched-out tabs.

FIG. 3 is a diagrammatic spatial view of a signature page with two tabs.

FIGS. 4a-4c show diagrammatic spatial views of the joining of the folded signatures by pulling the tabs through the slits.

FIGS. 5a-5d show diagrammatic spatial views of the individual method steps according to the invention, wherein the tabs are pulled through slits in the back.

FIG. 6 is a diagrammatic spatial view of a book block produced with the method according to the invention.

FIG. 7 is a diagrammatic view of the operation of fitting on a cover.

FIGS. 8a, 8b show a diagrammatic representation of joining folded signatures with the aid of separate tabs.

FIGS. 9-11 show diagrammatic representations, showing respectively one embodiment of a tab for joining signatures, as shown in FIGS. 8a and 8b.

### DETAILED DESCRIPTION OF THE INVENTION

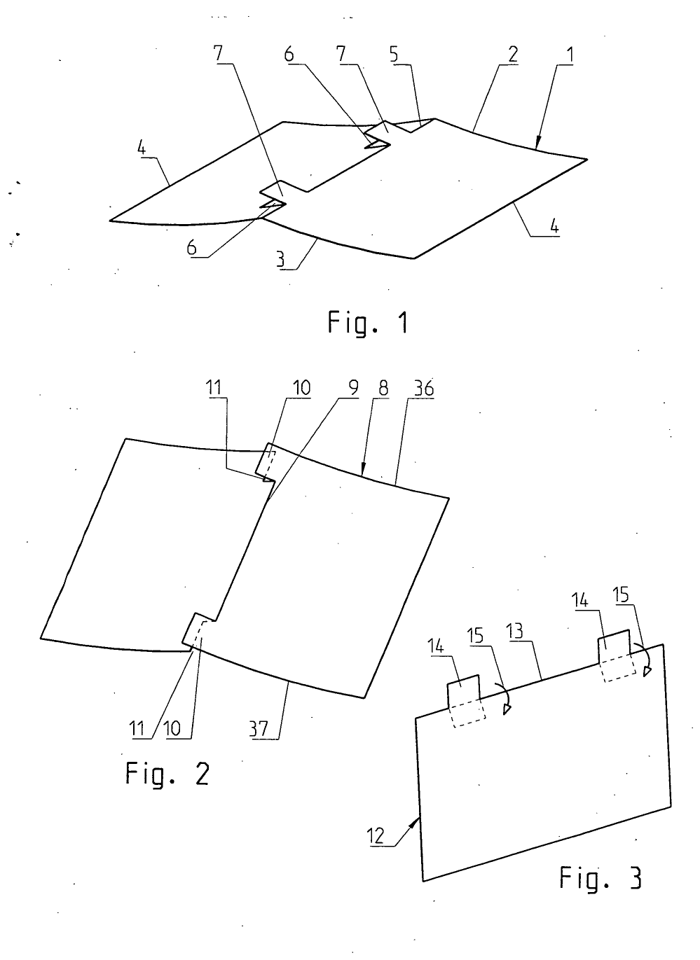

FIG. 1 shows a signature 1 with a fold 5. The signature is made of, for example paper, wherein the signature 1 can in principle also consist of a different material. The signature 1 is cut in particular into a rectangular shape and has a top edge 2, a bottom edge 3 as well as two parallel front edges 4. The fold 5 forms a back on which two tabs and/or flaps 7 are punched out at a distance to each other. These flaps 7 are joining flaps, as will be explained further below. Since the flaps 7 are punched out of the signature 1, the signature 1 has corresponding punching holes 6. In principle, the flaps 7 can also be produced by attaching and in particular gluing paper strips containing flaps onto the signature 1. With the signature 1, the flaps 7 as well as the punching holes 6 are arranged at a distance to the top edge 2 and the bottom edge 3. The punching holes 6 and/or the flaps 7 are thus located inside the signature 1.

FIG. 2 shows a signature 8 that is provided with two flaps 10, arranged at a distance to each other, which are also arranged in the region of a fold 9. The flaps 10 and the respective punching holes 11 in this case are arranged near the edge. Thus, the punching holes 11 are open on the side, as can be seen, and the flaps 10 form extensions of a top edge 36 and/or a bottom edge 37. The flaps 10 in this case can also be glued to the signature 8. If the flaps are glued to the inside of the signature, there are no punched-out holes 11, but only slits.

FIG. 3 shows a non-folded signature 12 (a signature), provided along a back edge 13 with two projecting flaps 14 that are arranged at a distance to each other. These flaps can also be arranged at the top or bottom edge, as is the case with the signature 8 shown in FIG. 2. These flaps 14 can be folded over by approximately 180° as shown with arrows 15. The signature 12 is not folded and thus is a simple signature of paper. The two flaps 14 can be produced through correspondingly cutting them out along the edges 13, wherein a punching out is also possible.

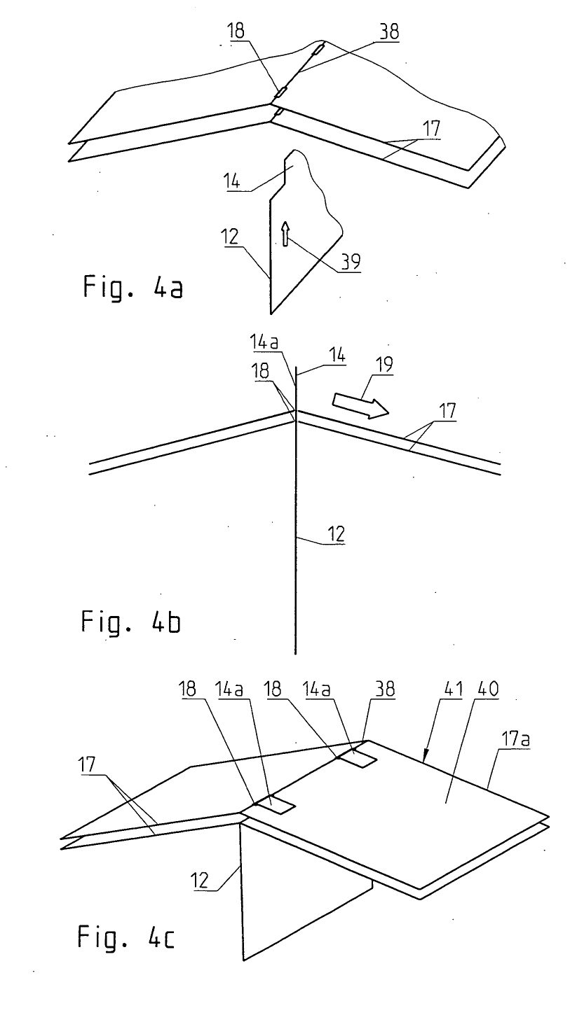

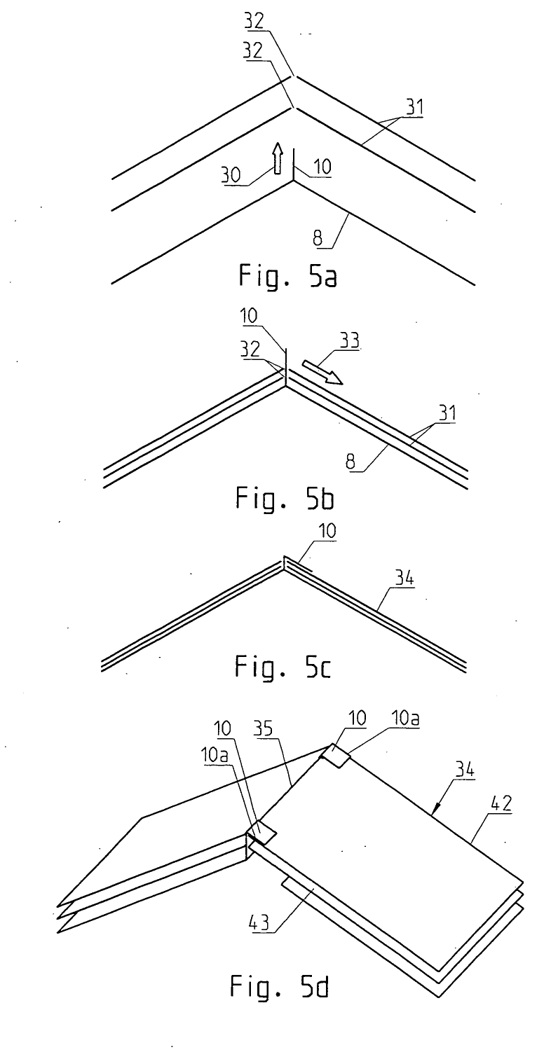

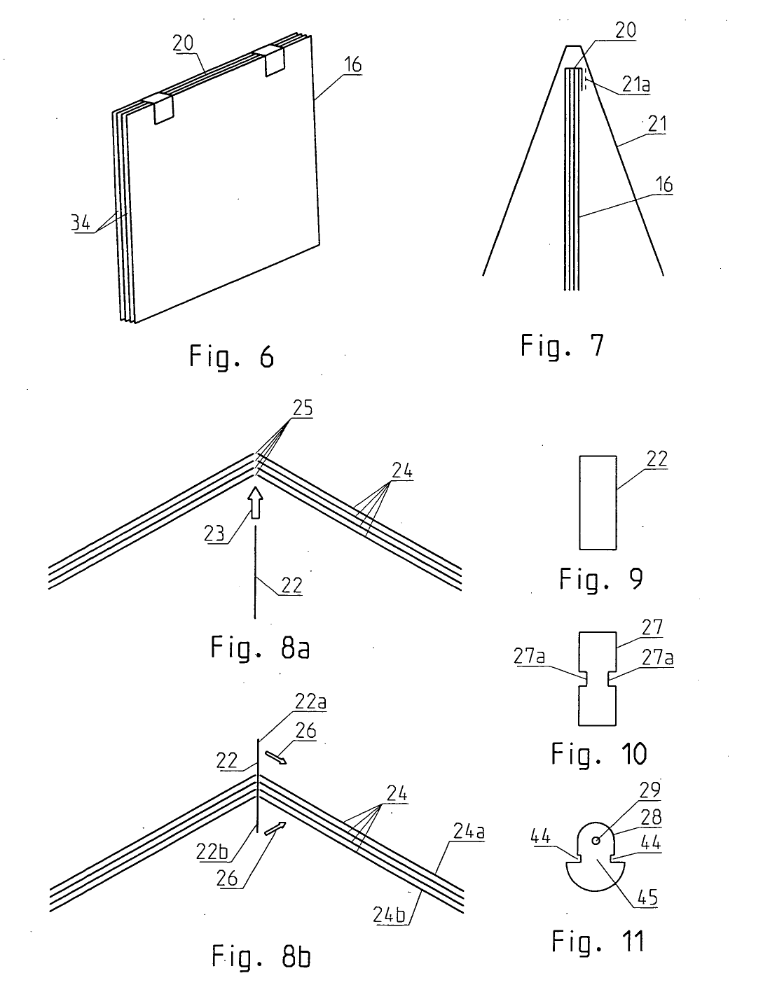

The method according to the invention is explained in further detail in the following with the aid of FIGS. 4a to 4c and 5a to 5d.

Two or more folded signatures 17 are joined with the aid of the non-folded signature 12, shown in FIG. 4a. The folded signatures 17 are provided with a fold 38 by suitably folding them and are then respectively provided in the fold 38 region with two slits 18, arranged at a distance to each other. The slits 18 are inserted along the line of fold 38 and can be cut into the signature 17, e.g. with a suitable knife, either before or after the folding. The positions and the length of the slits 18 correspond to the distances and lengths of the flaps 14. The folded signatures 17 that are provided with slits 18 are fitted against each other as shown in FIG. 4a. Of course, it is also possible to join more than two signatures 17. The non-folded signature 12 is then inserted into the partially opened signatures 17, as shown in FIG. 4a. The signature 12 is subsequently moved in the direction of arrow 19 to the position shown in FIG. 4b, wherein the two flaps 14 are pulled respectively into one of the slits 18. The slits 18 in the process can be pulled apart with a suitable device for pulling in the flaps 14. The length of flaps 14 is dimensioned such that they have an exposed end 14a which projects from the back side of signature 17, following the pulling in as shown in FIG. 4b. These exposed ends 14a are then folded over in the direction of arrow 19 and secured to the back side 40 of the outermost signature 17a, for example, by gluing the exposed ends 14a to the outside 40. The signature 12 as well as the signatures 17 are then joined securely and form a section 41. The flaps can also be used to join sections and, analog to the thread sealing, can form a book block. The open pages of section 41 are then cut in a suitable manner known per se with the aid of a cutting device. Also conceivable is an embodiment for which the signature 12 is provided with only one flap 14 or more than two flaps 14.

FIGS. 5a to 5d show the joining of two or more folded signatures 31 by means of the signature 8. The signatures 31 are provided respectively with two open slits 32 on the side, the length of which corresponds to the width of a flap 10. The signature 8 is inserted into the fitted-together signatures 31, as shown in FIG. 5a, and is moved so that the flaps 10 can be pulled through the slits 32. FIG. 5b shows the signature 8 with the flaps 10 pulled through the slits 32. If signature 8 and signatures 31 are fitted against each other, then the flaps 10 are folded over in the direction of arrow 33, as shown in FIG. 5b. These flaps 10 are secured to the back of the outermost signature 34, as explained in the above. The two flaps 10 are then aligned with respectively one outer edge 10a toward an open side 42 and/or 43. If separate tabs are used, e.g. according to FIG. 8a, 8b, these can also be provided in the direction of the back fold from the top and/or bottom side. Finally, the product produced in this way, which can be either a brochure or a book block, is bound into a cover 21. For example, the product 16 comprises one or several products 34 or sections which may be intermediate products.

Following the binding into the cover 21, the open sides are trimmed. The cover 21 can preferably be joined to the product 16 on the inside, by means of the flaps 10 or by gluing the sides along the back. However, the flaps 10 can also be pulled through the cover and can then be free to meet an additional function, for example, or they can be imprinted and designated as coupon. In that case, the flap 10 is preferably perforated for a partial removal.

FIGS. 8a and 8b show a method where separately produced, flexible, strip-like parts 22, 27 or 28 are used for joining the sections in place of the above-mentioned flaps 7, 10 and 14. In the same way as the flaps 7, 10 and 14, these parts 22, 27 and 28 comprises strip-shaped tabs and/or joining tabs.

To be able to join folded signatures 24 as shown in FIG. 8a, these are also folded and provided with slits 25. The slits 25 can also be arranged along the edge or at a distance to the edge, as shown in FIGS. 4c and/or 5d. The parts 22 correspond to the flaps 7, 10 and/or 14, but are attached individually and are not attached as part of a signature. If the signatures 24 are folded, provided with slits, and joined to each other, as shown in FIG. 8a, then the parts 22 are pulled either from the inside or the outside into the slits 25, in the direction of arrow 23. According to FIG. 8b, the parts are preferably pulled in such that one outer end 22a and one inner end 22b project. These ends 22a and 22b are folded over in accordance with arrows 26. The outer end 22a is secured on the back of an outermost signature 24a while the inner end 22b is attached to the inside of an innermost signature 24b, for example by gluing them on. The part 22 is a simple rectangular as well as elongated strip, as shown in FIG. 9, which can be made of paper or a plastic foil.

The part 27 shown in FIG. 10 is also an elongated tab and/or strip, provided in the center with opposite-arranged punched-out areas 27a, wherein the spacing between the punched-out areas corresponds approximately to the length of one slit into which a part 27 is pulled. As a result of the tapering in the region of the punched-out area 27a, the part 27 is secured in a longitudinal direction. The respective slits have the same length as the width of the part in the region of punched-out area 27a.

FIG. 11 shows a part 28 which is also provided with punched out areas 44 on the side for the fixation in a longitudinal direction. In addition, the part 28 is provided with a round hole 29 which, in the same way as an eyelet for filing, permits the filing in a ring binder which is not shown herein. In that case, the region with the round hole 29 is not fixated and can be folded over (folded back) or can project. The internal tab of part 28 can be formed on and/or glued on.

The slit into which the part 28 is pulled essentially has the same length as the width of web 45, formed as a result of the punched-out areas 44. The signatures 24 can also be combined with the aid of different parts 22, 27 and/or 28. For example, the signatures 24 can be held together by three parts 22 or 27 and two parts 28. In that case, the two parts 28 in particular form two eyelets for filing the product in a ring binder. The shapes of the flaps, tabs, etc can also vary within broad limits, e.g. they can be tapered in some regions to facilitate the pulling in.

The flaps can furthermore also form components (punched-out areas) of the outermost signature or the cover and can be pulled from the outside through the slits and then secured on the innermost signature.

The invention has been described in detail with respect to preferred embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

1. A method for binding graphic products formed of folded signatures securely joined along a folded back end of the signatures, comprising:
providing at least one flexible tab;
providing each signature, respectively, with at least one slit in a region of a fold; and
pulling the at least one tab into the at least one slit, respectively, for joining the signatures.

2. The method according to claim 1, wherein the at least one tab comprises a flap on a signature.

3. The method according to claim 2, including punching the flap out along the fold of a signature.

4. The method according to claim 1, wherein the flap is one of a) arranged on a non-folded signature and b) a part separate from the signatures.

5. The method according to claim 2, including arranging at least two flaps at a distance to each other on a signature and providing additional signatures with at least two slits, arranged at a distance to each other; and pulling the flaps through the slits.

6. The method according to claim 1, including folding the pulled-through tab over and securing it to an outside of a signature or on a cover.

7. The method according to claim 6, including attaching the flap to the outside of a signature or a cover.

8. The method according to claim 1, including providing the pulled-through tab with an opening for filing in a ring binder.

9. The method according to claim 1, including using the tab as a carrier for an advertisement.

10. The method according to claim 1, including bending over the tab which is pulled through the slits over and attaching to the pulled through tab to at least one signature.

11. The method according to claim 1, wherein the tab comprises one of paper, plastic and textile.

12. A graphic product produced with a method according to claim 1, wherein the product is one of a book, a brochure, and a magazine.

13. The graphic product according to claim 12, further comprising a plurality of folded signatures with slits along the respective fold lines, wherein the at least one flexible tabs is pulled through the slits to hold together the signatures.
